(19) United States
(12) Patent Application Publication
(10) Pub. No.: US 2025/0272545 A1
(43) Pub. Date: Aug. 28, 2025

(54) TIME-SERIES DIMENSION COMPRESSION

(71) Applicant: Koch Business Solutions, LP, Wichita, KS (US)

(72) Inventors: Maxim Kormilitsin, Dallas, TX (US); Abhishek Anand, Bangalore (IN); Nathan R. Hamilton, Wichita, KS (US)

(21) Appl. No.: 18/858,341

(22) PCT Filed: Jul. 26, 2022
(86) PCT No.: PCT/IB2022/056895

§ 371 Date: Oct. 21, 2024

(30) Foreign Application Priority Data
May 13, 2022 (IN) 202241027736

(51) Int. Cl. G06N 3/0455

(52) U.S. Cl. CPC G06N 3/0455

(57) ABSTRACT

A method for dimension compression of a set of time series includes (i) extracting from each time series a first vector of model parameters and a second vector of residuals and (ii) inputting the first and second vectors into an encoder, of an autoencoder, to embed the time series in a feature space. The resulting set of feature vectors are then clustered. For each cluster, at least one representative vector is then selected to represented all of the feature vectors in said each cluster. The representative vector may be a medoid or centroid of these feature vectors. A representative time series is then generated for each representative vector. For example, the representative vector may be inputted into a decoder, of the autoencoder, to generate the representative time series. Several parameters may be adjusted to vary the amount of compression and the amount of information lost via this compression.

### RELATED APPLICATIONS

This application claims priority to India application No. 202241027736, filed on May 13, 2022, the disclosure of which is incorporated herein by reference in its entirety.

### BACKGROUND

Time-series forecasting utilizes one or more time series to make future predictions for a target variable. Time-series forecasting may consume significant computing resources to implement, especially when the number of time series included in the forecasting is particularly large. For example, consider forecasting with a data set having one million time series. Assuming each of these time series represents monthly data (i.e., each data point represents one month) spanning 10 years, or 120 months, the size of the data set is approximately 120 million data points.

### SUMMARY

Feature selection refers to methods and techniques for identifying the most relevant features, or input variables, inputted to a machine-learning or statistical prediction model. The “relevance” of a feature quantifies how much the feature contributes to the model's ability to generate accurate predictions. By contrast, a variable is termed “irrelevant” when it has little, if any, contribution to the model's predictive abilities. Irrelevant variables may be excluded from the model with negligible impact on the model's accuracy while advantageously simplifying and speeding up execution of the model. Furthermore, some features may be highly correlated or strongly iterating. Since such variables are not all needed by the model, they are termed “redundant”. Accordingly, the goal of feature selection is to identify the most relevant features while excluding irrelevant and redundant features.

A large number of candidate features may be useful for forecasting by helping to identify the candidate features that are the most useful for predicting a target variable. However, a very large number of candidate features likely requires an excessive amounts of computer resources to process. Compression refers to techniques that reduce the amount of data needed to represent the candidate features while preserving their information content. For example, consider several candidate features that are similar to each other. Most of the information in these candidate features is redundant and therefore most of these candidate features can be simply discarded with minimal, if any, impact on feature-selection accuracy.

The present embodiments implement time-series dimension compression by identifying clusters of candidate features that are similar to each other. Herein, the “similarity” between two candidate features is a measure of how alike the two candidate features are. Similarity is quantified with a “similarity measure”. Examples of similarity measures include cosine similarity, Euclidean distance, and Manhattan distance. Two (or more) candidate features with a high similarity measure have nearly the same information content. Accordingly, one of the candidate features can be discarded.

The candidate features belonging to each cluster may be replaced with a single synthetic feature that has nearly the same information content of the candidate features of the cluster, but with significantly less data. In the present embodiments start, each candidate feature is embedded in a feature space as a feature vector. The resulting set of feature vectors are then clustered, where the feature vectors within each cluster represent similar candidate features. The feature vectors within each cluster are then compressed by identifying a representative vector to replace the feature vectors. The representative vector may be a medoid or centroid of the feature vectors. The representative vector may then be transformed into a representative time series that captures most of the information content of the candidate features in the cluster, but with less data.

The present embodiments may be used to both speed up the construction of a multivariate time-series-based prediction model and increase its accuracy by reducing the number of candidate features that need to be tested and evaluated for inclusion in the model. For some prediction models, up to one million candidate features, or more, may be considered, even though only a few may be relevant and included in the final model. Reducing the number of variables not only reduces the computational resources needed to run the final model, but it can also improve the model's accuracy since irrelevant features only add noise to the model. The removal of irrelevant and redundant features can also advantageously prevent overfitting.

One example of where the present embodiments may be beneficial is supply-chain demand forecasting, a critical business function that provides directional guidance to a business about the amount and type of product that should be produced for a given customer or location. Univariate statistical methods that only rely on historic sales or production data of a product will be limited by the extent that history repeats itself. Conversely, multivariate algorithms allow for factors (i.e., features) that impact demand to be included in the model and typically provide greater accuracy. Examples of such factors include unemployment rate, consumer confidence, commodity and futures pricing, and other factors that contribute to underlying demand. The process of determining which factor or factors will increase predictive accuracy added to a multivariate predication model is time consuming and typically done through manual analysis. As a result, only a small number of external features typically informed by discussions with subject-matter experts are evaluated to determine their potential to increase accuracy.

The present embodiments advantageously save time for analysts and subject-matter experts by accelerating time-to-value, improving prediction accuracy and the quality of the most valuable features included in the forecasting model. Also, the ability to evaluate a large volume of features can lead to the discovery of economic and business factors impacting demand that are insightful and new knowledge that subject-matter experts and decision makers might find valuable in improving their understanding of the business. Additionally, once a model is moved to production, the automated review of enrichment data helps the model stay performant over time, and saves significant time required to continue evaluating new features. As a result, supply-chain demand forecasts stay more accurate.

### BRIEF DESCRIPTION OF THE FIGURES

FIG. 1 illustrates a method for compressing a set of time series, in embodiments.

FIG. 2 illustrates an encoder that may be trained to generate a feature vector as a lower-dimension representation of an input vector, in an embodiment.

FIG. 3 illustrates a decoder that transforms a representative vector into a representative time series, in an embodiment.

FIG. 4 is a plot of illustrates the trade-off between the amount of compression and the informational content.

FIG. 5 is a functional diagram of a system that implements the present method embodiments, in embodiments.

FIG. 6 is a functional diagram of a big-data system that expands the system of FIG. 5 to operate with a data repository, in an embodiment.

### DETAILED DESCRIPTION

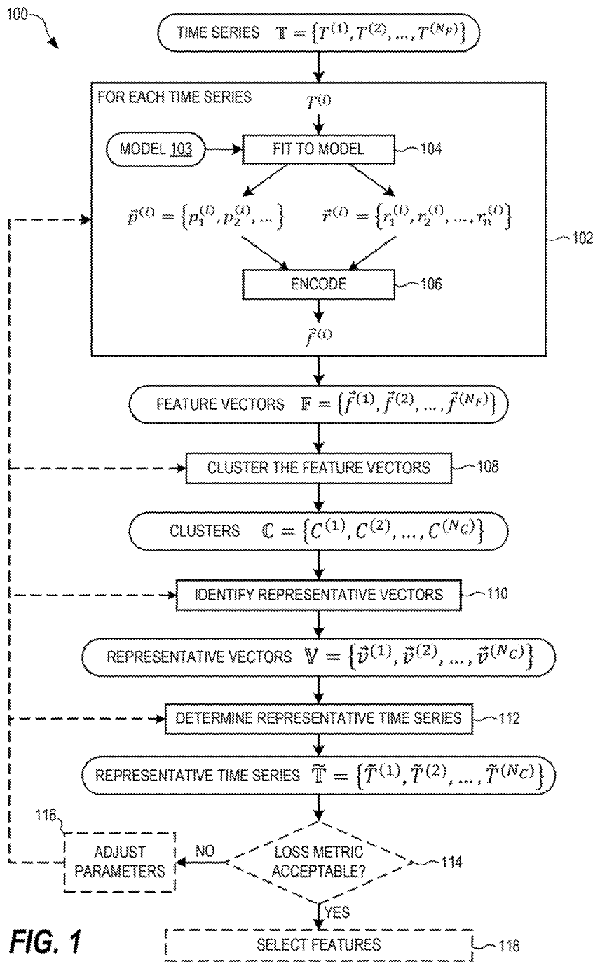

FIG. 1 illustrates a method 100 for compressing a set of time series [symbol] ={T⁽¹⁾, T⁽²⁾, . . . , T^{(N}^{_{F}}⁾}. Each time series represents one variable, or feature, and is denoted T⁽ⁱ⁾, where i is an index between 1 and the number N_{F} of time series, or features, within the set [symbol] (i.e., 1≤i≤N_{F}). The j^{th} data point Tⱼ⁽ⁱ⁾ of the i^{th} time series is denoted by the ordered pair Tⱼ⁽ⁱ⁾=(tⱼ⁽ⁱ⁾,yⱼ⁽ⁱ⁾), where j is an index between 1 and the number n of data points in the time series (i.e., 1≤j≤n) and yⱼ⁽ⁱ⁾ is the value of the feature at the time tⱼ⁽ⁱ⁾.

For clarity in the following description, it is assumed that the N_{F} time series in the set [symbol] are temporally aligned, i.e., they all have the same number n of data points and the same values for the times t₁, t₂, . . . , tₙ. However, the present embodiments are applicable to time series that are not temporally aligned. In such instances, the embodiments herein may pre-process the time series by applying techniques known in the art to align time series (e.g., interpolation, extrapolation, averaging, discarding points, etc.). The data points may be uniformly spaced in time (i.e., t₂−t₁=t₃−t₂= . . . =tₙ−tₙ₋₁) or non-uniformly spaced in time. In any case, each data point in any one of the aligned time series forms a one-to-one correspondence, based on time, with one data point in each of the other N_{F}−1 aligned time series.

In the block 102 of the method 100, each time series T⁽ⁱ⁾ is embedded as a corresponding feature vector \vec{f}⁽ⁱ⁾ in a feature space. FIG. 1 shows one embodiment of the block 102 in which each time series T⁽ⁱ⁾ is fit to a model (see the block 104) to generate a corresponding model-parameter vector \vec{p}⁽ⁱ⁾={p₁⁽ⁱ⁾, p₂⁽ⁱ⁾, . . . } and residuals vector \vec{r}⁽ⁱ⁾={r₁⁽ⁱ⁾, r₂⁽ⁱ⁾, . . . rₙ⁽ⁱ⁾}. Here, the number nₚ of model parameters p⁽ⁱ⁾ in the vector \vec{p}⁽ⁱ⁾ depends on the model. For example, when each time series T⁽ⁱ⁾ has monthly data and the model is a seasonal autoregressive integrated moving average (SARIMA) of the form

$${y}_{j} = {β}_{1} {y}_{t - 12} + {β}_{2} {y}_{t - 1} + {β}_{3} {y}_{t - 4} + {β}_{4} {r}_{t - 1} + {r}_{t} , \qquad ( 1 )$$

then the model-parameter vector \vec{p}⁽ⁱ⁾={β₁,β₂,β₃,β₄} has four elements. In this example, the SARIMA model has a seasonality period of 12 months. The orders of the SARIMA model are ((1,4),0,1)(1,0,0). However, the SARIMA model may have different orders without departing from the scope hereof. For example, the seasonality period may have a value other than 12 months. Furthermore, another type of time-series model, or combination of time-series models, may be used without departing from the scope hereof. Examples of such alternative time-series models include, but are not limited to, AR, MA, NMA, ARMA, ARIMA, FARIMA, GARCH, GARCH+ARIMA, ARMAX, and NARX.

In the embodiment shown in FIG. 1, the block 102 also includes a block 106 in which the model-parameter vector \vec{p}⁽ⁱ⁾ and residuals vector \vec{r}⁽ⁱ⁾ are encoded into the feature vector \vec{f}⁽ⁱ⁾. The feature vector \vec{f}⁽ⁱ⁾ has fewer dimensions than n+nₚ, and therefore the block 106 implements dimensionality reduction. In some embodiments, the feature vector \vec{f}⁽ⁱ⁾ has fewer dimensions than n. This encoding may be implemented using feature projection, such as principal component analysis, discriminant analysis, autoencoding, t-distributed stochastic neighbor embedding, self-organizing map, or another type of dimensionality-reduction technique known in the art. When n is particularly large, this encoding may improve performance by reducing the deleterious effects of the curse of dimensionality (e.g., during clustering in the block 108).

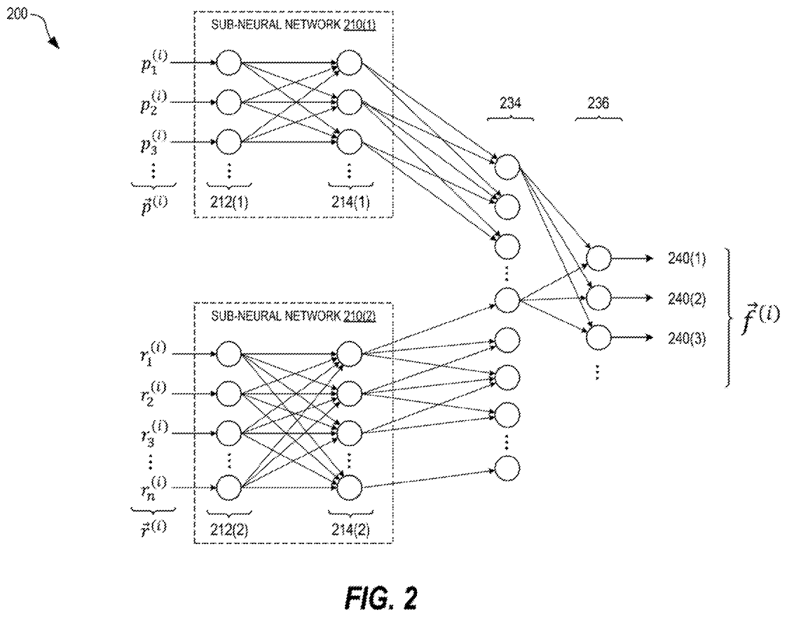

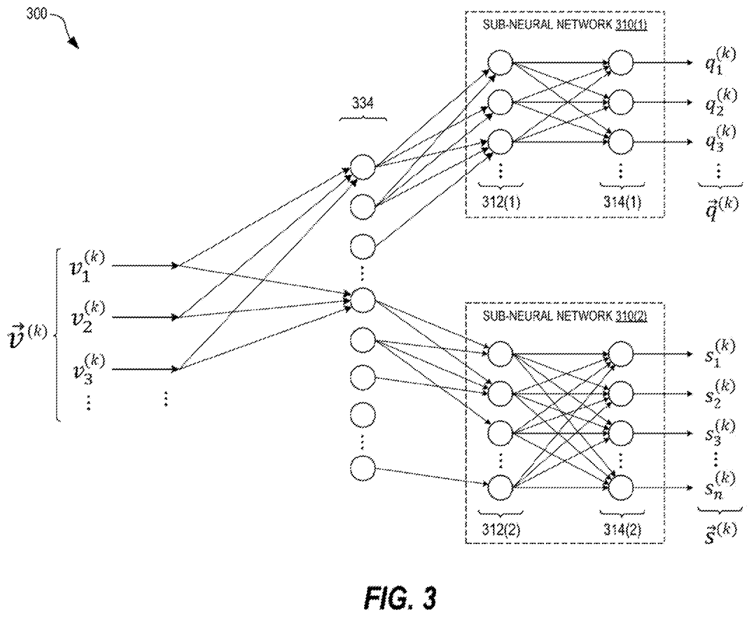

FIG. 2 illustrates an encoder 200 that may be trained to generate the feature vector \vec{f}⁽ⁱ⁾ of FIG. 1 as a lower-dimensional representation of an input vector. The encoder 200 is a feed-forward artificial neural network in which neurons are represented as circles while connections between neurons (i.e., weights) are indicated by arrows. The encoder 200 may be combined with a corresponding decoder (e.g., see the decoder 300 of FIG. 3) to form an autoencoder. The encoder 200 has a first sub-neural network 210(1) that receives the model-parameter vector \vec{p}⁽ⁱ⁾ as an input. Each model parameter pⱼ⁽ⁱ⁾ is inputted into one corresponding input neuron of a first input layer 212(1) of the first sub-neural network 210(1), and therefore the number of input neurons in the first input layer 212(2) equals the number of model-parameters in the model-parameter vector \vec{p}⁽ⁱ⁾. The first sub-neural network 210(1) also includes a first output layer 214(1). As shown in FIG. 2, the first output layer 214(1) has the same number of neurons as the first input layer 212(1) and is fully connected to the first input layer 212(1). However, the first output layer 214(1) may have a different number of neurons than the first input layer 212(2). Similarly, the first output layer 214(1) may be sparsely connected to the first input layer 212(1). Although not shown in FIG. 2, the first sub-neural network 210(1) may include one or more hidden layers between the first input layer 212(1) and the first output layer 214(1) without departing from the scope hereof.

The encoder 200 also has a second sub-neural network 212(2) that receives the residuals vector \vec{r}⁽ⁱ⁾ as an input. Each residual rⱼ⁽ⁱ⁾ is inputted into one corresponding input neuron of a second input layer 212(2) of the second sub-neural network 210(2), and therefore the number of input neurons in the second input layer 212(2) equals n. The second sub-neural network 210(2) also includes a second output layer 214(2) that may also have n neurons. The second output layer 214(2) may be fully connected to the second input layer 212(2), as shown in FIG. 2, or sparsely connected. Although not shown in FIG. 2, the second sub-neural network 210(2) may include one or more hidden layers between the second input layer 212(2) and the second output layer 214(2) without departing from the scope hereof.

The sub-neural networks 210(1) and 210(2) are fully separated in that no neuron of the first sub-neural network 210(1) directly connects to any neuron of the second sub-neural network 210(2), and vice versa. Herein, two neurons connect “directly” to each other when there is an edge between them and no intervening neuron. The encoder 200 also includes a concatenation layer 234 that is directly fed by the outputs of the sub-neural networks 210(1) and 210(2). The concatenation layer 234 may be either fully or sparsely connected to one or both of the output layers 214(1) and 214(2). Advantageously, the encoder 200 operates faster and with less memory by using the fully separated sub-neural networks 210(1) and 210(2), as compared to an architecture in which the concatenation layer 234 serves as the input layer.

The encoder also includes a bottleneck layer 236 that is directly fed by the concatenation layer 234. To implement dimensionality reduction, the number of neurons in the bottleneck layer 236 is less than the number of neurons in the concatenation layer 234. The bottleneck layer 236 may be fully or sparsely connected to the concatenation layer 234. In either case, each neuron of the bottleneck layer 236 generates a corresponding output 240. These outputs 240 may be combined into an n-tuple that represents the feature vector \vec{f}⁽ⁱ⁾. While FIG. 2 shows the bottleneck layer 236 having three neurons, the bottleneck layer 236 may have a different number of neurons without departing from the scope hereof. Although not shown in FIG. 2, the encoder 200 may include one or more additional layers between the concatenation layer 234 and the bottleneck layer 236.

Referring to FIG. 1, the output of the block 102 is a set [symbol] of N_{F} feature vectors [symbol] ={\vec{f}⁽¹⁾, \vec{f}⁽²⁾, . . . , f^{(N}^{_{F}}⁾}. In the block 108 of the method 100, the set [symbol] is clustered according to any clustering technique known in the art. Examples include, but are not limited to, k-means clustering, k-medoids clustering, density-based clustering, and hierarchical clustering. The output of the block 108 is a set of clusters [symbol] ={C⁽¹⁾, C⁽²⁾, . . . , C^{(N}^{_{C}}⁾}, where N_{C} is the number of clusters in the set [symbol] .

In the block 110 of the method 100, a representative vector \vec{v}^{(k)} is identified based on the feature vectors belonging to the cluster C^{(k)}, where k is an index between 1 and N_{C} (i.e., 1≤k≤N_{C}). In one embodiment, only one representative vector \vec{v}^{(k)} is identified for each cluster C^{(k)}. In this embodiment, the output of the block 110 is a set of N_{C} representative vectors [symbol] ={\vec{v}⁽¹⁾, \vec{v}⁽²⁾, . . . , v^{(N}^{_{C}}⁾} forming a one-to-one correspondence with the N_{C} clusters of the set [symbol] . In another embodiment, more than one representative vector is identified for one or more of the clusters of the set [symbol] . In this embodiment, there are more than N_{C} representative vectors in the set [symbol] . In another embodiment, one or more of the clusters are discarded after the block 108, in which case there is no need to identify a representative vector for any cluster that is discarded. It is assumed herein that the set [symbol] excludes any such discarded clusters, and therefore at least one representative vector is identified for each cluster belonging to the set [symbol] .

In some embodiments, the representative vector \vec{v}^{(k)} equals one of the feature vectors belonging to the cluster C^{(k)}. For example, the representative vector \vec{v}^{(k)} may be the medoid of these feature vectors. In other embodiments, the representative vector \vec{v}^{(k)} is calculated as a weighted sum (i.e., a linear combination) of the feature vectors belonging to the cluster C^{(k)}. For example, the weights may be chosen such that the representative vector \vec{v}^{(k)} is the mean or centroid of these feature vectors. In other embodiments, the representative vector \vec{v}^{(k)} is calculated nonlinearly from one or more of the feature vectors belonging to the cluster C^{(k)}. Another technique or method to identify, select, or calculate the representative vector \vec{v}^{(k)} based on the feature vectors in the cluster C^{(k)} may be used without departing from the scope hereof.

In some embodiments, the same method for identifying the representative vector \vec{v}^{(k)} is used for all of the clusters in the set C. In other embodiments, different methods are used to identify the representative vector \vec{v}^{(k)} for different clusters. The choice of method may be based on the feature vectors in the cluster C^{(k)}. For example, the variance, skew, or another statistical measure of the feature vectors in the cluster C^{(k)} may be used to determine how the representative vector \vec{v}^{(k)} is calculated from these feature vectors.

In the block 112 of the method 100, a representative time series \tilde{T}^{(k)} is determined for each representative vector \vec{v}^{(k)}. The output of the block 112 is a set of N_{C} representative time series [symbol] ={\tilde{T}⁽¹⁾, \tilde{T}⁽²⁾, . . . , \tilde{T}^{(N}^{_{C}}⁾}. When the representative vector \vec{v}^{(k)} equals one of the feature vector \vec{f}⁽ⁱ⁾, then the representative time series \tilde{T}^{(k)} may be simply set equal to the time series T⁽ⁱ⁾ associated with the feature vector \vec{f}⁽ⁱ⁾. For example, the representative vector \vec{v}^{(k)} may be identified in the block 110 as being equal to one of the feature vectors belonging to the cluster C^{(k)} (e.g., a medoid of the cluster C^{(k)}). In this case, the time series T⁽ⁱ⁾ associated with this one feature vector may be selected from the set [symbol] as the representative time series \tilde{T}^{(k)}.

FIG. 3 illustrates a decoder 300 that transforms the representative vector \vec{v}^{(k)} into the representative time series \tilde{T}^{(k)}. The decoder 300 may be used when the representative vector \vec{v}^{(k)} does not belong to the cluster C^{(k)}. In this case, the decoder 300 is used to construct a representative time series (k) that is synthetic (i.e., differs from all other time series belonging to the set [symbol] ). During training, the decoder 300 is fed by the bottleneck layer 236 of the encoder 200, thereby forming an autoencoder that generates the feature vector \vec{f}⁽ⁱ⁾ as a reduced-dimension representation of an input vector. After training, the decoder 300 is severed from the encoder 200 so that the encoder 200 and decoder 300 can be used independently. FIG. 3 illustrates use of the decoder 300 after it has been severed.

Similar to many autoencoders, the decoder 300 has an architecture (i.e., number of layers, number of neurons, connections between layers, etc.) that is the inverse of that of the encoder 200 (without the bottleneck layer 236). Thus, in the example of FIGS. 2 and 3, the decoder 300 has an input layer 334 that corresponds to the concatenation layer 234 of the encoder 200, a sub-neural network 310(1) that corresponds to the first sub-neural network 210(1) of the encoder 200, and a sub-neural network 310(2) that corresponds to the second sub-neural network 210(2) of the encoder 200. The representative vector \vec{v}^{(k)} is inputted to the decoder 300 by feeding each component of the representative vector \vec{v}^{(k)} into one or more input neurons of the input layer 334. As indicated by the arrows in FIG. 3, each of these components may be weighted prior to being fed into a neuron of the input layer 334.

A first subset of the neurons of the input layer 334 feeds an input layer 312(1) of the sub-neural network 310(1) while a remaining subset of the neurons of the input layer 334 feeds an input layer 312(2) of the sub-neural network 310(2). Like the sub-neural networks 210(1) and 210(2), the sub-neural networks 310(1) and 310(2) are fully separated from each other. Each neuron of an output layer 314(1) of the sub-neural network 310(1) generates one corresponding component of a synthesized model-parameter vector \vec{q}^{(k)}. Each component of the vector \vec{q}^{(k)} is interpreted as the same model parameter of the time-series model 103 as the identically-indexed component of the vector \vec{p}^{(k)} (i.e., \vec{q}⁽¹⁾ and \vec{p}⁽¹⁾ represent the same parameter, \vec{q}⁽²⁾ and \vec{p}⁽²⁾ represent the same parameter, etc.) Each neuron of an output layer 314(2) of the sub-neural network 310(2) generates one corresponding component of a synthesized residuals vector \vec{s}^{(k)} having n elements. Although not shown in FIG. 3, the vectors \vec{q}^{(k)} and \vec{s}^{(k)} may be used with the time-series model 103 to construct the representative time series \tilde{T}^{(k)}.

In some embodiments, the method 100 includes a decision block 116 that determines if information loss of the set [symbol] is acceptable. As part of the decision block 116, an information-loss metric is calculated. Examples of such an information-loss metric include, but are not limited to, a coefficient of determination R², Shannon information, entropy, cross-correlation, and variance. The information-loss metric may be calculated by comparing each representative time series in the set [symbol] to one or more of the original time series in the set [symbol] . For example, a cross-correlation coefficient may be calculated between the representative time series \tilde{T}^{(k)} and each time series T⁽ⁱ⁾ whose feature vector \vec{f}⁽ⁱ⁾ belongs to the cluster C^{(k)}. These cross-correlation coefficients may be averaged together, or otherwise combined, to form a single cross-correlation value for the cluster C^{(k)}. The cross-correlation values for all the clusters C^{(k)} in the set [symbol] may be similarly averaged together, or otherwise combined, to form a single value for the information-loss metric. Alternatively, the information-loss metric may be calculated by comparing each representative vector \vec{v}^{(k)} in the set [symbol] to one or more of the feature vectors belonging to the cluster C^{(k)}. For example, the Euclidean distance (or another distance distance) in the feature space may be calculated between the representative vector \vec{v}^{(k)} and each feature vector belonging to the cluster C^{(k)}. A sum-of-squares may then be calculated from these distances. These sums-of-squares may be averaged together, or otherwise combined, to form a single value for the information-loss metric.

In some embodiments, the value of the information-loss metric is not calculated based on all of the representative time series in the set [symbol] . Rather, several representative time series may be randomly selected from the set [symbol] and used to calculate a sampled value of the information-loss metric. Given the very large number of time series in the set [symbol] , and possibly also in the set [symbol] , this stochastic method of sampling the information-loss metric can reduce the computational resources need to determine if the information loss is acceptable, thereby speeding up execution of the method 100.

In one example of the decision block 116, the information-loss metric is compared to a threshold. If the information-loss metric is below the threshold, then the information loss is acceptable and the method 100 may continue (e.g., to the block 118). If the information-loss metric is above the threshold, then the information loss is too great. In this case, the method 100 may iterate by continuing to the block 116 in which one or more parameters of the method 100 are adjusted. The method 100 then returns to one of the blocks 102, 108, 110, and 112, as shown in FIG. 1, from which it continues to generate an updated set [symbol] of representative time series having a new value of the information-loss metric. The method 100 may continue iterating in this manner until the information loss is acceptable. Examples of the one or more parameters that can be adjusted as part of the block 116 are described in more detail below.

In another example of the decision block 116, the value of the information-loss metric is compared to a target. If the value agrees with the target to within a tolerance level (i.e., the absolute value of the difference between the value and the target is less than the tolerance level), then the method 100 may continue (e.g., to the block 118). Otherwise, the method 100 iterates by continuing to the block 116. When there is too much information loss, the parameters may be adjusted to preserve more information. Generally, this will require less compression (e.g., increasing the number of clusters N_{C}). However, there may alternatively be too little information loss, in which case the parameters may be adjusted to achieve additional compression until a maximum tolerable level of information loss is achieved.

In some embodiments, the value of the information-loss metric is displayed to a user so that the user can select, based on the value of the information-loss metric that is displayed, which parameters of the method 100 to adjust. In this case, the user may select parameters to adjust by considering the cost of computing resources required to implementing changes to these parameters.

All of the feature vectors within a single cluster lie close to each other in the feature space, and therefore the time series represented by these feature vectors are similar to each other. Specifically, all pairs of feature vectors within the single cluster have a similarity measure that is relatively high (e.g., above a threshold). Due to their similarity, most of the informational content of the feature vectors within any one cluster is redundant, i.e., only a small amount of each feature vector's information is different from that of the other feature vectors in the cluster. By replacing several similar feature vectors with one representative vector, the present embodiments advantageously eliminate most of this redundant information while minimally eliminating the independent information. This reduction of unnecessary information reduces the computational resources (e.g., memory, speed, etc.) needed for subsequent feature selection (e.g., see the block 116 in FIG. 1) without significantly degrading the accuracy of this feature selection.

The closer the feature vectors are to each other in the feature space, the greater the similarity between their corresponding time series. In this case, the replacement of several feature vectors with one representative vector discards mostly redundant information and little independent information. Accordingly, it may be advantageous to increase the number of clusters, as this usually results in a smaller volume of the feature space enclosed by each cluster, thereby ensuring that the feature vectors within the cluster lie closer to each other. However, if the number of clusters is increased too much, and the volume of the feature space enclosed by each cluster becomes too small, then the number of feature vectors within each cluster decreases. In this case, replacing all of the feature vectors in each cluster with one representative cluster does not discard as much redundant information. Accordingly, it should be recognized that there is a trade-off between the amount of compression (i.e., the amount of both redundant and independent information that is discarded) and the accuracy of the subsequent feature selection (i.e., the amount of only the independent information).

In some embodiments, the similarity of a pair of time series is quantified with a similarity measure that is applied only to like components of the pair of time series. For example, when time series are fit to the SARIMA model of Eqn. 1, each time series may be expressed as the sum of a seasonal component and residuals. In this case, the similarity measure can be calculated using only the seasonal components, or only the residuals. Other models may give rise to additional components that identify other trends. These additional components may also be used to determine similarity. Note that when similarity is determined for components of time series (as opposed to the entire time series), the architecture of the encoder 200 of FIG. 2 and decoder 300 of FIG. 3 will likely need to be reconfigured to accommodate different inputs and outputs.

In some embodiments, one or more of the time series in the set [symbol] are given imputed data to accommodate time series with different historical durations. In these embodiments, all of the time series are given the same length (i.e., the same number n of data points), which is chosen to equal the value of n of the longest time series in the set [symbol] . For shorter time series, missing data at earlier times is imputed. For each time series with imputed data, indicators are used to identify which time steps represent imputed data. These indicators may be passed to the encoder 200 so that it can learn to differentiate between original and imputed data.

In some embodiments, each time series T⁽ⁱ⁾ is processed using a recurrent neural network (RNN) instead of fitting to a model. For example, the RNN may include one or more long short-term memory (LSTM) networks. In these embodiments, the data points of the time series T⁽ⁱ⁾ are fed sequentially into the RNN. Sequential outputs of the RNN are then collected into an output vector whose elements are fed in parallel to the input neurons of the encoder 200, where the number of elements matches the number of input neurons. In these embodiments, the encoder 200 need not have fully separated sub-neural networks 210. A similar RNN may also be used to process the output of the decoder 300 into the representative time series \tilde{T}^{(k)}.

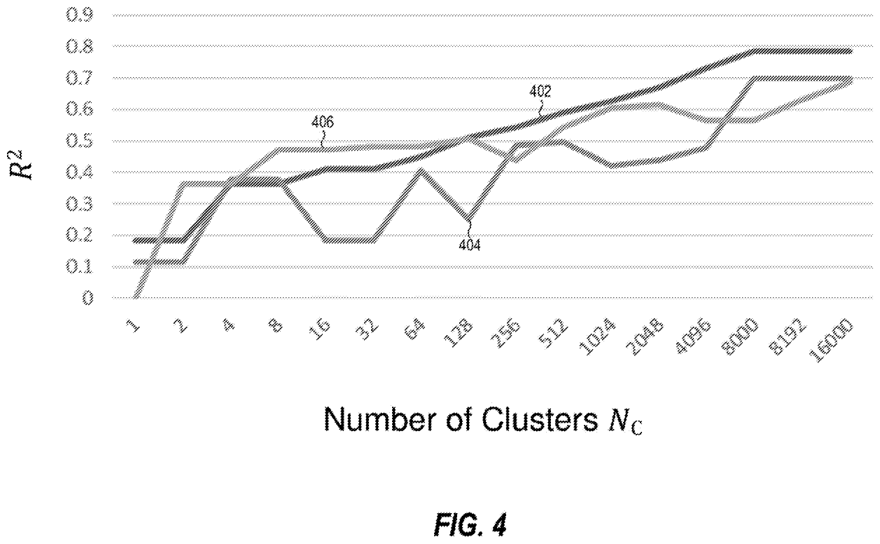

FIG. 4 is a plot that illustrates this trade-off. FIG. 4 shows how the number of clusters N_{C} is a parameter that can be adjusted (e.g., during the block 116) to change the value of the information-loss metric. To generate FIG. 4, an initial set [symbol] of several hundred thousand time series was selected. The y-axis of FIG. 4 quantifies informational content via the coefficient of determination R², where a value of R² closer to 1 indicates less information loss (i.e., improved preservation of information). The x-axis of FIG. 4 represents the number of clusters N_{C} in the set [symbol] . For all values of N_{C}, each cluster C^{(k)} was represented by one representative vector \vec{v}^{(k)} that was compared to the feature vectors belonging to the cluster C^{(k)} to obtain one value of R². For each value of N_{C}, the N_{C} values of R² were grouped into ten deciles, from which an average value of R² was calculated and plotted.

FIG. 4 shows a data series 402 in which each representative vector \vec{v}^{(k)} is the medoid of the cluster C^{(k)}, a data series 404 in which one-dimensional t-distributed stochastic neighbor embedding (TSNE) was used to enhance clustering via dimensionality reduction, and a data series 406 in which two-dimensional TSNE was used to enhance clustering. As shown in FIG. 4, as the number of clusters N_{C} increases, there are fewer feature vectors belonging to each cluster C^{(k)}, and thus R² approaches 1. The data series 402 and 406 have similar values of R² near N_{C}=128 clusters, however as N_{C} decreases clustering with two-dimensional TSNE performs better. For N_{C}>128, medoid clustering outperforms clustering based on one-dimensional or two-dimensional TSNE. Thus, a user may vary the number of clusters to find a balance between information loss and the amount of compression.

FIG. 4 also illustrates how the choice of clustering technique is a parameter that may be adjusted to change the information-loss metric. Similarly, dimensionality reduction from the feature space to a low-dimensional space (e.g., TSNE, self-organizing maps, generative topographic mapping, linear local embedding, etc.) may be added (e.g., as part of the block 108) to improve the clustering (and possible at the expense of additional information loss). Parameters of these dimensionality-reduction techniques may also be adjusted as part of the block 116 (e.g., the number of dimensions of the low-dimensionality space).

Other parameters of the method 100 that may be adjusted to change the value of the information-loss metric include the technique used to determine each representative vector \vec{v}^{(k)} (e.g., medoids vs. centroids) and the mathematical formula used to calculate the centroid of each cluster. The choice of time-series model 103 may also be adjusted. However, changing the time-series model 103 will likely require re-training of the autoencoder (i.e., the encoder 200 of FIG. 2 and the decoder 300 of FIG. 3). Such re-training may be prohibitively expensive in terms of computational resources needed. However, several autoencoders may be pre-trained (i.e., before the method 100 begins) for different time-series models, allowing different encoders and/or decoders to be selected as part of the block 116.

Parameters of the encoder 200 and decoder 300 may also be adjusted to change the value of the information-loss metric, even if the time-series model 103 is not adjusted. Examples of such parameters include the number of layers, the number of neurons in the bottleneck layer 236, and the connections between layers. Changing these parameters will require re-training of the autoencoder, which may be prohibitively expensive in terms of computational resources needed. However, several autoencoders may be pre-trained for the same time-series model 103, thereby allowing different encoders and/or decoders to be selected as part of the block 116.

The method 100 need not return to the block 102 when parameters associated with the block 102 are not adjusted. For example, when neither the time-series model 103 nor the encoder 200 is changed, the method 100 from proceed directly from the block 116 to the block 108, thereby saving computational resources by bypassing the block 102. Furthermore, when no parameter associated with the block 108 (e.g., the number of clusters N_{C} and type of clustering technique) is adjusted, the method 100 from proceed directly from the block 116 to the block 110, thereby saving additional resources by also bypassing the block 108. Furthermore, when no parameter associated with the block 110 (e.g., the method of identifying each representative vector \vec{v}^{(k)}) is adjusted, the method 100 from proceed directly from the block 116 to the block 112, thereby saving additional resources by also bypassing the block 110.

In some embodiments of the method 100, one or more representative time series belonging to the set [symbol] are outputted (see the block 116). For example, the set [symbol] may be transmitted (e.g., via a computer network) to a computer that uses the one or more representative time series for another application. As one example of such an application, each representative time series in the set [symbol] is used as one input variable for feature selection. Thus, in some embodiments of the method 100, a plurality of candidate features are feature ranked (see the block 118), the plurality of candidate features including one or more of the representative time series belong to the set [symbol] .

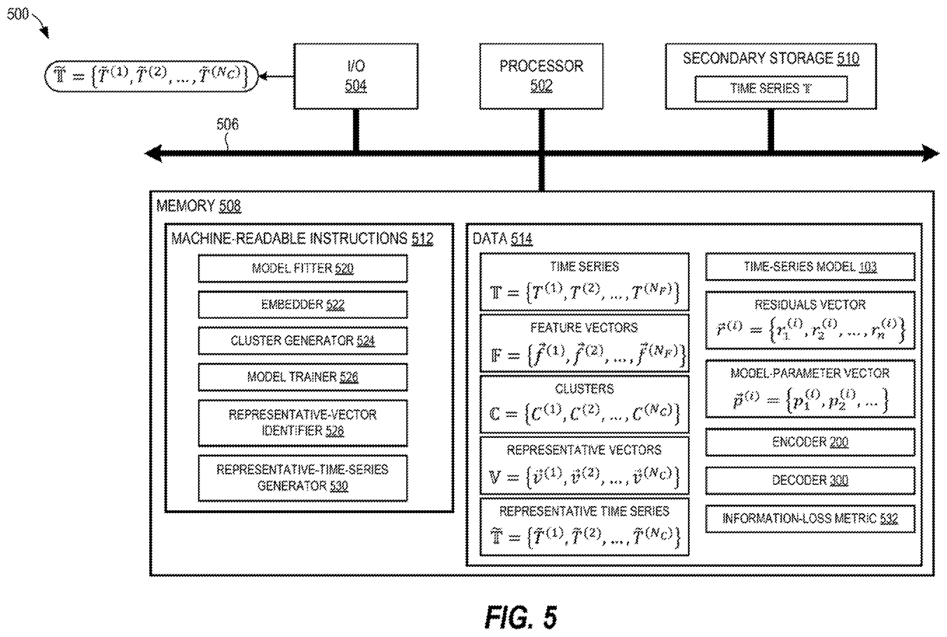

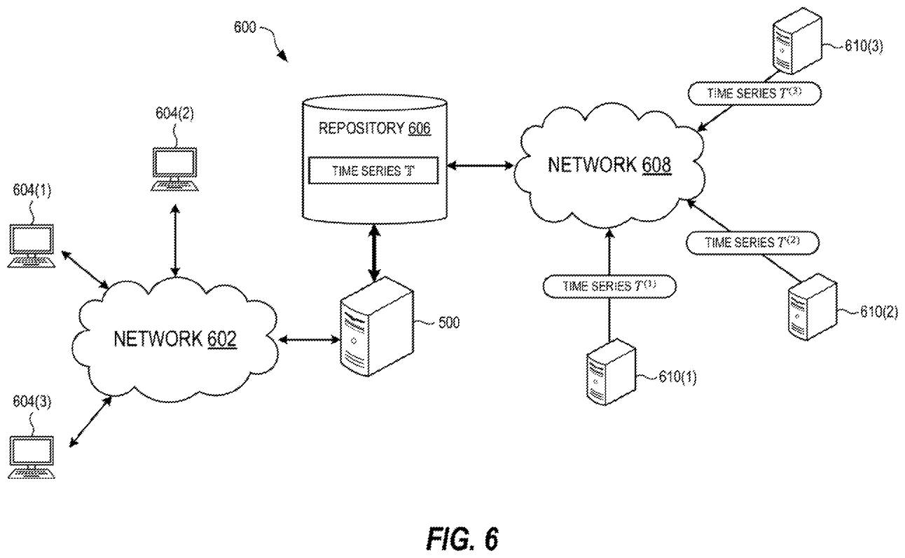

FIG. 5 is a functional diagram of a system 500 that implements the present method embodiments. The system 500 is a computing device having a processor 502, memory 508, and secondary storage device 510 that communicate with each other over a system bus 506. For example, the memory 508 may be volatile RAM located proximate to the processor 502, while the secondary storage device 510 may be a hard disk drive, a solid-state drive, an optical storage device, or another type of persistent data storage. The secondary storage device 510 may alternatively be accessed via an external network instead of the system bus 506 (e.g., see FIG. 6). Additional and/or other types of the memory 508 and the secondary storage device 510 may be used without departing from the scope hereof.

The system 500 may include at least one I/O block 504 that outputs some or all of the set [symbol] of representative time series to a peripheral device (not shown). The I/O block 504 is connected to the system bus 506 and therefore can communicate with the processor 502 and the memory 508. In some embodiments, the peripheral device is a monitor or screen that displays one of more of the representative time series (e.g., as a time-series chart or list in human-readable format). Alternatively, the I/O block 804 may implement a wired network interface (e.g., Ethernet, Infiniband, Fibre Channel, etc.), a wireless network interface (e.g., WiFi, Bluetooth, BLE, etc.), a cellular network interface (e.g., 4G, 5G, LTE), an optical network interface (e.g., SONET, SDH, IrDA, etc.), a multi-media card interface (e.g., SD card, Compact Flash, etc.), or another type of communication port through which the system 500 can communicate with another device.

The processor 502 may be any type of circuit or integrated circuit capable of performing logic, control, and input/output operations. For example, the processor 502 may include one or more of a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC). The processor 502 may also include a memory controller, bus controller, and other components that manage data flow between the processor 502, memory 508, and other components connected to the system bus 506.

The memory 508 stores machine-readable instructions 512 that, when executed by the processor 502, control the system 500 to implement the functionality and methods described herein. The memory 508 also stores data 514 used by the processor 502 when executing the machine-readable instructions 512. In the example of FIG. 5, the data 514 includes the set of N_{F} time series [symbol] ={T⁽¹⁾, T⁽²⁾, . . . , T^{(N}^{_{F}}⁾}, the set of N_{F} feature vectors [symbol] ={\vec{f}⁽¹⁾, \vec{f}⁽²⁾, . . . , \vec{f}^{(N}^{_{F}}⁾}, the set of N_{C} clusters [symbol] ={C⁽¹⁾, C⁽²⁾, . . . , C^{(N}^{_{C}}⁾}, the set of N_{C} representative vectors [symbol] ={\vec{v}⁽¹⁾, \vec{v}⁽²⁾, . . . , \vec{v}^{(N}^{_{C}}⁾}, the set of N_{C} representative time series [symbol] ={\tilde{T}⁽¹⁾, \tilde{T}⁽²⁾, . . . , \tilde{T}^{(N}^{_{C}}⁾}, the time-series model 103, at least one model-parameter vector \vec{p}⁽ⁱ⁾={\vec{p}₁⁽ⁱ⁾, \vec{p}₂⁽ⁱ⁾, . . . }, at least one residuals vector \vec{r}⁽ⁱ⁾={r₁⁽ⁱ⁾, r₂⁽ⁱ⁾, . . . rₙ⁽ⁱ⁾}, the encoder 200, the decoder 300, and an information-loss metric 532. The memory 508 may store additional data 514 than shown in FIG. 5. In addition, some or all of the data 514 may be stored in the secondary storage device 510 and fetched therefrom when needed. In the example of FIG. 5, the secondary storage device 510 stores the set [symbol] . However, the secondary storage device 510 may store additional or other data than shown without departing from the scope hereof.

In the example of FIG. 5, the machine-readable instructions 512 include a model fitter 520, an embedder 522, a cluster generator 524, a representative-vector identifier 526, and a representative-time-series generator 530. The model fitter 520 fits a time series T⁽ⁱ⁾ to the time-series model 103, thereby implementing the block 104 of the method 100. The embedder 522 uses the encoder 200, as stored in the data 514, to embed the model-parameter vector \vec{p}⁽ⁱ⁾ and residuals vector \vec{r}⁽ⁱ⁾ into the feature space, thereby implementing the block 106 of the method 100. The cluster generator 524 performs clustering of the set [symbol] of feature vectors, thereby implementing the block 108 of the method 100. The representative-vector identifier 526 identifies at least one representative vector \vec{v}^{(k)} for each cluster in the set [symbol] , thereby implementing the block 110 of the method 100. The representative-time-series generator 530 generates one representative time series \tilde{T}^{(k)} for each representative vector \vec{v}^{(k)}. Although not shown in FIG. 5, the memory 508 may also store machine-readable instructions 512 to implement one or more of the block 114, 116, and 118. The memory 508 may store additional machine-readable instructions 512 than shown in FIG. 5 without departing from the scope hereof.

FIG. 6 is a functional diagram of a big-data system 600 that expands the system 500 of FIG. 5 to operate with a data repository 606. In many cases, the number of times series N_{f} in the set [symbol] is so large (e.g., millions, or more) that a computer architecture designed for big-data applications is required. To address the challenges of these situations, the system 500 may interface with the data repository 606, which is designed to store and quickly retrieve such large volumes of data. The data repository 606 may be a data lake, a data warehouse, a database server, or another type of big-data or enterprise-level storage system. In some embodiments, the data repository 606 is implemented as cloud storage that the system 500 accesses remotely (e.g., over the internet). The system 500 may be, or form part of, a supercomputer, a computer cluster, a distributed computing system, or another type of high-performance computing system with the resources to process the data.

In the example of FIG. 6, the data repository 606 aggregates data retrieved from one or more data stores 610. For example, the data repository 606 may receive, via a network 608 (e.g., the internet, a wide area network, a local area network, etc.), a first time series T⁽¹⁾ for a first feature from a first data store 910(1), a second time series T⁽²⁾ for a second feature f₂ from a second data store 910(2), and so on. The data repository 606 may store data that is structured (e.g., as in a relational database), unstructured (e.g., as in a data lake), semi-structured (e.g., as in a document-oriented database), or any combination thereof. The system 500 is configured as a server that communicates with one or more clients 604 over a network 602. Each client 604 may interface with the system 500 (e.g., via the I/O block 504) to start execution of the time-series compression, adjust parameters, and receive results (e.g., one or more of the set [symbol] ).

The big-data system 600 separates the tasks of collecting and integrating time-series from the task of time-series compression, allowing users to advantageously focus on time-series compression without the need to understand many, if any, technical details related to the data repository 606. Furthermore, the network-based architecture shown in FIG. 6 allows many users to access and use the system 500 simultaneously, and thereby benefit from the effort required to construct and maintain a storage system capable of handling such large quantities of data.

### Demonstration

As a demonstration of the present embodiments, an experiment was conducted to quantify how much the present embodiments can improve predictions of the S&P 500 stock market index. In a first run, time-series data from 400,000 features was processed using the model-independent feature selection described in International Patent Application No. PCT/IB2021/054134, the subject matter of which is incorporated herein by reference in its entirety. In a second run, the same 400,000 features were first processed using the present embodiments to obtain a smaller set of 140,000 features that was subsequently processed using the model-independent feature selection.

The first run took 12 hours to complete while the second run took only 30 minutes. Therefore, a 24-fold reduction in run time was obtained by using the present embodiments. To determine the quality of the ranked features, the top 50 features from each of the runs were compared to the S&P 500 data for 2017 and 2019. The mean average error (MAE) of the top 50 features from the second run was 36% lower than the MAE of the top 50 features from the first run. Similarly, the room-mean-square error (RMSE) of the top 50 features from the second run was 30% lower than the RMSE of the top 50 features from the first run. These results show that the present embodiments help feature selection to identify features with greater predictive power.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A method for data series compression, comprising:
for each data series of a plurality of data series:
extracting from said each data series a first vector of model parameters and a second vector of residuals; and
inputting the first and second vectors into an encoder, of an autoencoder, to embed said each data series in a feature space as one of a corresponding plurality of feature vectors;
clustering the plurality of feature vectors to obtain a plurality of clusters;
identifying, for at least one cluster of the plurality of clusters, a representative vector based on the feature vectors belonging to the at least one cluster; and
determining, based on the representative vector, a representative data series.

2. The method of claim 1, wherein:
said identifying includes identifying, as the representative vector, one of the plurality of feature vectors belonging to the at least one cluster; and
said determining includes selecting, as the representative data series, the one of the plurality of data series corresponding to said one of the plurality of feature vectors.

3. The method of claim 1, wherein said determining includes:
inputting the representative vector into a decoder of the autoencoder to obtain a third vector of model parameters and a fourth vector of residuals; and
constructing the representative data series based on the third and fourth vectors.

4. The method of claim 1, wherein said identifying includes identifying more than one representative vector for the at least one cluster.

5. The method of claim 1, wherein:
said identifying includes identifying, for each of the plurality of clusters, a corresponding one of a plurality of representative vectors; and
said determining includes determining, for each of the plurality of representative vectors, a corresponding one of a plurality of representative data series.

6. The method of claim 1, further comprising outputting the representative data series.

7. The method of claim 1, further comprising feature ranking a plurality of candidate features that include the representative data series.

8. The method of claim 1, wherein said extracting includes fitting said each data series to a data series model.

9. The method of claim 1, wherein said extracting includes decomposing said each data series.

10. The method of claim 1, wherein said clustering includes agglomerative clustering.

11. The method of claim 1, wherein said identifying the representative vector includes calculating a mid-point of the feature vectors belonging to the at least one cluster.

12. The method of claim 1, wherein said identifying the representative vector includes calculating a centroid or medoid of the feature vectors belonging to the at least one cluster.

13. The method of claim 1, wherein said identifying the representative vector includes calculating a weighted sum of the feature vectors belonging to the at least one cluster.

14. A system for data series compression, comprising:
a processor;
a memory in electronic communication with the processor, the memory storing a plurality of data series; and
a data series compression engine implemented as machine-readable instructions that are stored in the memory and, when executed by the processor, control the system to:
for each data series of the plurality of data series:
(i) extract from said each data series a first vector of model parameters and a second vector of residuals, and
(ii) input the first and second vectors into an encoder, of an autoencoder, to embed said each data series in a feature space as one of a corresponding plurality of feature vectors,
cluster the plurality of feature vectors to obtain a plurality of clusters,
identify, for at least one cluster of the plurality of clusters, a representative vector based on the feature vectors belonging to the at least one cluster, and
determine, based on the representative vector, a representative data series.

15. The system of claim 14, wherein:
the machine-readable instructions that, when executed by the processor, control the system to identify include machine-readable instructions that, when executed by the processor, control the system to identify, as the representative vector, one of the plurality of feature vectors belonging to the at least one cluster; and
the machine-readable instructions that, when executed by the processor, control the system to determine include machine-readable instructions that, when executed by the processor, control the system to select, as the representative data series, the one of the plurality of data series corresponding to said one of the plurality of feature vectors.

16. The system of claim 14, wherein the machine-readable instructions that, when executed by the processor, control the system to determine include machine-readable instructions that, when executed by the processor, control the system to:
input the representative vector into a decoder of the autoencoder to obtain a third vector of model parameters and a fourth vector of residuals, and
construct the representative data series based on the third and fourth vectors.

17. (canceled)

18. (canceled)

19. (canceled)

20. (canceled)

21. (canceled)

22. (canceled)

23. (canceled)

24. (canceled)

25. (canceled)

26. (canceled)

27. The method of claim 1, wherein each of the plurality of data series is a time series, wherein the representative data series is a representative time series, wherein the representative time series provides a replacement data series for at least two of the time series over a same time period.

28. The method of claim 27, further comprising utilizing the replacement time series for time series forecasting in place of the plurality of time series.

29. The method of claim 1, wherein the replacement data series provides a replacement data series for at least two of the data series of the plurality of data series.

30. The method of claim 1, wherein clustering the plurality of feature vectors to obtain the plurality of clusters is based on a similarity measure of two or more feature vectors, such that each cluster includes similar feature vectors.

31. The method of claim 30, wherein the similarity measure is based on at least one of a cosine similarity, a Euclidean distance, or a Manhattan distance.
